(19) United States
(12) Patent Application Publication
(10) Pub. No.: US 2011/0286087 A1
(43) Pub. Date: Nov. 24, 2011

(54) PROJECTION OPTICAL SYSTEM AND PROJECTION TYPE DISPLAY USING THE SAME

(76) Inventor: Tomoyuki BABA, Saitama-shi (JP)

(21) Appl. No.: 13/195,656

(22) Filed: Aug. 1, 2011

Related U.S. Application Data
(62) Division of application No. 12/420,600, filed on Apr. 8, 2009.

(30) Foreign Application Priority Data
Apr. 9, 2008 (JP) P2008-101705
Apr. 9, 2008 (JP) P2008-101706

(51) Int. Cl. G02B 17/08

(52) U.S. Cl. 359/364

(57) ABSTRACT

A luminous flux optically modulated by an image display device is projected to be magnified on a screen by a projection optical system includes: a first optical system having a positive first lens group including eight lenses, a negative second lens group including three lenses, and a third lens group including an aspheric single lens; and a second optical system including an aspheric reflecting mirror. The projection optical system is an off-axial optical system, and forms the intermediate image between the first optical system and the second optical system. Moreover, the expressions T1/Y<12.5 and T12/f1<6.0 are satisfied where T1 is the overall length of the first optical system, Y is the maximum light ray height on an image display device, T12 is the distance between the first optical system and the second optical system, and f1 is the focal length of the first optical system.

### CROSS-REFERENCE TO RELATED APPLICATIONS

This application is a Divisional of co-pending application Ser. No. 12/420,600, filed on Apr. 8, 2009, and for which priority is claimed under 35 U.S.C. §120. This application claims priority under 35 USC 119 from Japanese Patent Application No. 2008-101705 filed Apr. 9, 2008, and Japanese Patent Application No. 2008-101706 filed Apr. 9, 2008; the entire contents of which are incorporated herein by reference.

### BACKGROUND

1. Technical Field

The present invention relates to a projection optical system and a projection type display, and more particularly, to a projection optical system that forms an image displayed on an image display device, on a screen by using a first optical system including a plurality of lenses and a second optical system including a concave mirror, and a projection type display using the same.

2. Related Art

As projection optical systems for projection type displays and projection type televisions, one constituted by a dioptric system using optical glass are widely known. And in recent years, a reflecting mirror is used as a part of a projection optical system in order to improve the chromatic aberration caused by the optical glass and increase the angle of view.

In particular, for example, the projection optical systems of Patent References 1 (JP-A-2006-235516 corresponding to US-A-2006-0193036) and 2 (JP-A-2007-79524 corresponding to US-A-2007-0184368) shown below are an oblique projection type in which optical elements are tilted from the optical axis in order to meet the demand for apparatus size reduction, and further, an aspheric mirror is used as the above-mentioned reflecting mirror in order to reduce a large keystone distortion caused in such an oblique projection type optical system.

However, the optical systems described in these patent references are all intended mainly for being mounted in a rear projection type, and although they are made compact, they are required to be more compact when used for a front projection type. That is, since the front projection type is required to be convenient to carry and be placed on a desk when projection is performed, the optical system is required to be further largely reduced in size. Here, the optical system may be reduced in size in the direction of the optical axis thereof.

And it is necessary that the image plane on the screen and the optical axis of the first optical system be disposed apart from each other in order to prevent the light ray reflected by the reflecting mirror from interfering with the lenses of the first optical system, particularly, with the most magnification side lens having a large diameter when the light ray travels toward the screen. So, apparatus size may be reduced by reducing the distance to the optical axis of the first optical system in the vertical direction.

### SUMMARY

The present invention is made in view of such circumstances, and an object thereof is to provide a projection optical system and a projection-type display capable of meeting, a request for the reduction in the apparatus size of the first optical system also when the optical system is used for the front projection type while aberrations such as chromatic aberration and trapezoidal distortion are excellently maintained.

According to an aspect of the invention, a first projection optical system that projects and magnifies an image being on an image display device which is a reduction-side conjugate plane of a pair of conjugate planes, onto a screen which is a magnification-side conjugate plane of the pair of conjugate planes, and includes, in order from the image-display device side: a first optical system that includes a plurality of lenses and forms as an intermediate image from the image being on the image display device; and a second optical system that includes a concave mirror having a concave surface directed toward the first optical system and forms the intermediate image on the screen. The following conditional expression (1) is satisfied:

T1/Y<12.5 (1)

where T1 is the overall length of the first optical system and Y is the maximum light ray height on the image display device.

In the above-described projection optical system, it is preferable to satisfy the following conditional expression (2):

T12/f1<6.0 (2)

where T12 is the distance between the first optical system and the second optical system and f1 is the focal length of the first optical system.

According to another aspect of the invention, a second projection optical system that projects and magnifies, an image on an image display device which is a reduction-side conjugate plane of a pair of conjugate planes, onto a screen which is a magnification-side conjugate plane of the pair of conjugate planes, includes, in order from the image-display-device side: a first optical system that includes a plurality of lenses and forms an intermediate image being on the image display device; and a second optical system that includes a concave mirror having a concave surface directed toward the first optical system and forms the intermediate image on the screen. The first optical system includes, in order from the image-display-device side: a first lens group having a positive refractive power; a second lens group having a negative refractive power; and a third lens group including at least one aspheric lens.

In the above-described projection optical system, it is preferable that focus adjustment is performed by moving the second optical system and the first lens group and the second lens group of the first optical system in the direction of the optical axis.

According to another aspect of the invention, a third projection optical system that projects and magnifies, an image being on an image display device which is a reduction-side conjugate plane of a pair of conjugate planes, onto a screen which is a magnification-side conjugate plane of the pair of conjugate planes, includes, in order from the side of the image display device: a first optical system that includes a plurality of lenses and forms an intermediate image from the image being on the image display device; and a second optical system that includes a concave mirror having a concave surface directed toward the first optical system and forms the intermediate image on the screen. A lens situated on the most magnification side in the first optical system has a rotationally asymmetric shape. A part of said lens is missing. And the missing part is outside the effective area of the lens and interferes with a light ray traveling from the second optical system toward the screen.

It is preferable that the following conditional expression (3) is satisfied:

Ymin/Ymax<0.35 (3)

where Ymin is the distance between a point the nearest to the optical axis of the first optical system and the optical axis of the first optical system and Ymax is the distance between a point the farthest from the optical axis of the first optical system and the optical axis of the first optical system in a position within the projection image plane on the screen.

The concave mirror may have a rotationally symmetric aspheric shape or a rotationally asymmetric aspheric shape.

It is preferable that the first optical system includes at least one aspheric lens.

In this case, it is preferable that the aspheric lens of the first optical system has a rotationally symmetric aspheric shape.

It is preferable that the first optical system and the second optical system have a common optical axis.

A projection type display of the present invention has any of the above-described projection optical systems.

According the first projection optical system and the projection type display using the same of the present invention, the overall length T1 of the first optical system with respect to the maximum light ray height Y on the image display device is set so as to be within a range smaller than 12.5. That is, since the size of the projection optical system is reduced, first, by reducing the overall length of the first optical system, by setting the overall length T1 of the first optical system so as to be smaller than 12.5 with respect to the maximum light ray height Y on the image display device, the apparatus size can be reduced to a sufficiently satisfactory degree also when the optical system is mounted in the front projection type.

The first optical system and the second optical system are disposed in order from the side of the reduction side conjugate plane of the pair of conjugate planes, the first optical system includes a plurality of lenses, the second optical system includes the reflecting mirror having an aspheric concave configuration, and the intermediate image is formed between the first optical system and the second optical system. Consequently, even though the angle of incidence is large in the oblique incidence optical system, a real image with little distortion can be formed on the screen by using a small number of reflecting mirrors, and the generation of chromatic aberration can be suppressed compared with when the projection optical system is constituted only by a dioptric system. Moreover, since the second optical system includes one reflecting mirror, the assembly of the optical system is easy, and the size reduction of the apparatus can be promoted.

Since the intermediate image is formed between the first optical system and the second optical system, the size of the mirror in the second optical system can be made small.

According to the second projection optical system and the projection type display using the same of the present invention, the first optical system and the second optical system are disposed in order from the side of the reduction side conjugate plane of the pair of conjugate planes, the first optical system includes from the side of the image display device a first lens group having positive refractive power, a second lens group having negative refractive power, and a third lens group having low refractive power (having positive or negative refractive power), the second optical system includes the reflecting mirror having an aspheric concave configuration, and the intermediate image is formed between the first optical system and the second optical system. Consequently, even though the angle of incidence is large in the oblique incidence optical system, a real image with little distortion can be formed on the screen by using a small number of reflecting mirrors, and the generation of chromatic aberration can be suppressed compared with when the projection optical system is constituted only by a dioptric system. Moreover, since the second optical system includes one reflecting mirror, the assembly of the optical system is easy, and the size reduction of the apparatus can be promoted.

Since the intermediate image is formed between the first optical system and the second optical system, the size of the mirror of the second optical system can be made small.

According to the third projection optical system and the projection type display of the present invention, since the distance between the image plane on the screen and the optical axis of the first optical system can be significantly reduced when the light ray traveling from the reflecting mirror toward the screen starts to interfere with the most magnification side lens of the first optical system, the apparatus size in the direction vertical to the optical axis of the first optical system can be reduced.

Since the first optical system can be disposed nearer to the reflecting mirror for the same purpose, the apparatus size in the direction of the optical axis of the first optical system can be reduced.

Thereby, the overall size of the apparatus can be largely reduced.

The first optical system and the second optical system are disposed in order from the side of the reduction side conjugate plane of the pair of conjugate planes, the first optical system includes a plurality of lenses, and the second optical system includes the reflecting mirror having an aspheric concave configuration. Consequently, even though the angle of incidence is large in the oblique incidence optical system, a real image with little distortion can be formed on the screen by using a small number of reflecting mirrors, and the generation of chromatic aberration can be suppressed compared with when the projection optical system is constituted only by a dioptric system. Moreover, since the second optical system includes one reflecting mirror, the assembly of the optical system is easy, and the size reduction of the apparatus can be promoted.

Since the intermediate image is formed between the first optical system and the second optical system, the size of the mirror of the second optical system can be made small.

### BRIEF DESCRIPTION OF THE DRAWINGS

FIG. 1 is a view showing the structure of a projection type display according to a first example.

FIG. 2 is a view showing the structure of a projection optical system according to the first example.

FIG. 3 is a view showing part of the projection optical system of the first example in detail.

FIG. 4 is a view showing the lateral aberrations of the projection optical system according to the first example;

FIG. 5 is a view showing the structure of a projection type display according to a second example.

FIG. 6 is a view showing the structure of a projection optical system according to the second example.

FIG. 7 is a view showing part of the projection optical system of the second example in detail.

FIG. 8 is a view showing the lateral aberrations of the projection optical system according to the second example.

### DETAILED DESCRIPTION

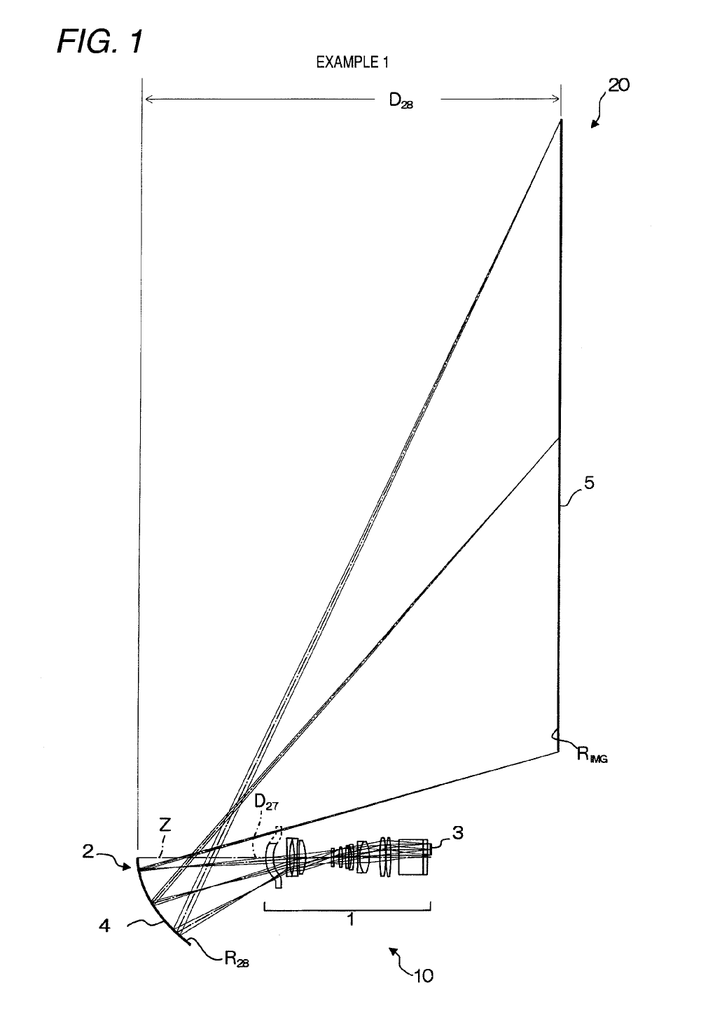

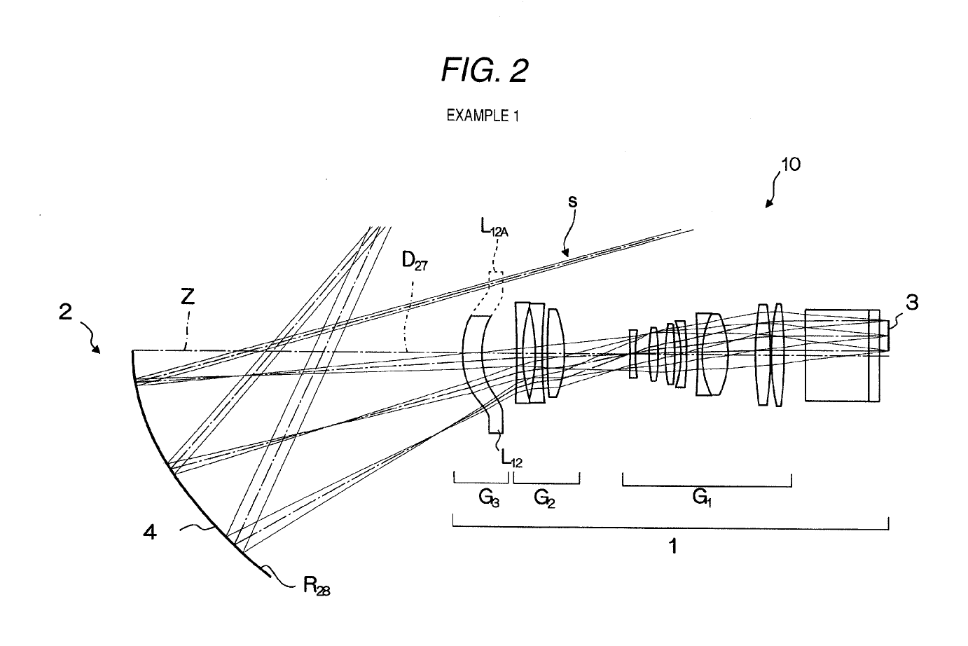

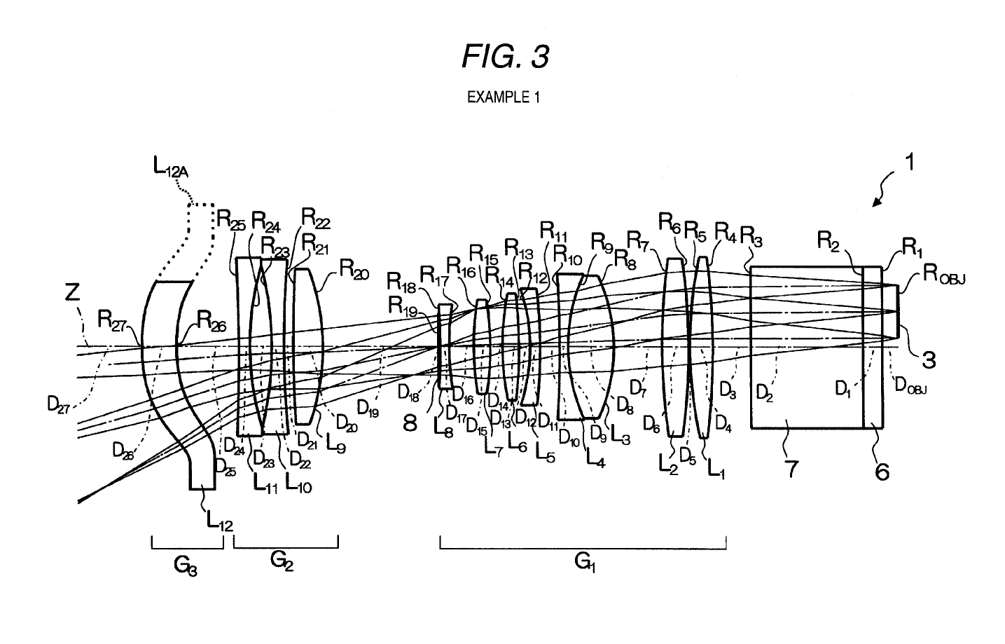

Hereinafter, an embodiment of the projection optical system and the projection type display using the same according to the present invention will be described with reference to FIGS. 1 to 3. FIG. 1 shows a projection type display 20 according to the embodiment of the present invention. FIG. 2 shows a projection optical system 10 according to the embodiment of the present invention. FIG. 3 shows the lens arrangement of a first optical system 1 of the projection optical system 10 so as to be magnified.

The projection type display 20 applies a luminous flux from a light source (not shown) to an image display device 3 through an illumination optical section (not shown), and projects, so as to be enlarged, the luminous flux optically modulated by the image display device 3 and carrying image information onto a screen 5 from the front side (viewer's side) by the first optical system 1 consisting of a projection optical system and a second optical system 2 consisting of one reflecting mirror 4. The screen 5 and the image display device 3 are disposed so as to substantially coincide with the magnification side conjugate plane of the projection optical system 10 and the reduction side conjugate plane of the projection optical system 10, respectively. A cover glass (plane-parallel plate) 6 and a prism section (a color composition prism, an optical deflection prism, etc.) 7 are disposed on the light exit side of the image display device 3. The intermediate image is formed between the first optical system 1 and the second optical system 2.

The projection optical system 10 according to the present embodiment is an off-axial optical system, and in the reflecting mirror 4, one side of the optical axis Z (the part below the optical axis Z in FIG. 1) is used as an effective light reflection area. By using only a light ray deflecting to one side as described above, the screen 5 can be disposed in a position as shown in FIG. 1, whereby the thickness reduction and size reduction of the apparatus can be achieved to some extent.

The elements of the projection optical system 10 are substantially plane-symmetric with respect to the plane of FIG. 1 (plane of symmetry), so that the assembly of the optical system can be made easy.

The projection optical system 10 according to the present embodiment is structured so as to satisfy the following conditional expression (1):

T1/Y<12.5 (1)

where T1 denotes the overall length of the first optical system 1 and Y is the maximum light ray height on the image display device 3.

Since the size reduction of the projection optical system 10 is significantly affected by the overall size of the first optical system 1, the overall length T1 of the first optical system is set so as to be smaller than 12.5 with respect to the maximum light ray height Y on the image display device 3, whereby the apparatus size can be reduced to a sufficiently satisfactory degree also when the optical system is mounted in the front projection type required to have portability and desktop operability.

When the following conditional expression (1′) is satisfied instead of the conditional expression (1), the above-mentioned operational advantage can be made remarkably excellent:

T1/Y<10.0 (1′)

Further, it is preferable to structure the projection optical system 10 according to the present embodiment so as to satisfy a conditional expression (2) shown below.

That is, the size reduction of the projection optical system 10 can be made more reliable by satisfying the conditional expression (2) in addition to satisfying the conditional expression (1) or the conditional expression (1′):

T12/f1<6.0 (2)

where T12 is the distance between the first optical system 1 and the second optical system 2 and f1 is the focal length of the first optical system 1.

When the conditional expression (2′) shown below is satisfied instead of the conditional expression (2), the above-mentioned operational advantage can be made remarkably excellent:

T12/f1<5.5 (2′)

In the projection optical system 10 according to the present embodiment, the first optical system 1 includes three lens groups G₁ to G₃, and includes in order from the object side: the first lens group G₁ having a positive power (including eight lenses in a first embodiment described later and seven lenses in a second example described later); the second lens group G₂ having a negative power (including three lenses in both the first and second examples); and the third lens group G₃ including one aspheric lens having low refractive power. The third lens group G₃ is intended mainly for aberration correction.

Moreover, in the projection optical system 10 of the present embodiment, the second optical system 2 includes one reflecting mirror 4 as mentioned above. When the second optical system 2 includes a plurality of reflecting mirrors, the alignment adjustment is difficult, and the assembly error inevitably caused thereby makes it difficult to maintain performance. On the contrary, in the projection optical system of the present embodiment, since the second optical system 2 is configured by a single reflecting mirror 4, the assembly error is small, the performance of the optical system is easy to maintain, and the size reduction of the apparatus can be promoted.

It is preferable that the focus adjustment of the projection optical system 10 according to the present embodiment is performed by moving the second optical system 2 and the first lens group G₁ and the second lens group G₂ in the first optical system 1 along the optical axis Z of the first optical system 1.

In the projection optical system 10 according to the present embodiment structured as described above, even though the angle of incidence is large in the oblique incidence optical system, a real image with little distortion can be formed on the screen by using a small number of reflecting mirrors, and the generation of chromatic aberration can be suppressed compared with when the projection optical system is constituted only by a dioptric system.

In the optical system of the present embodiment, the most magnification side aspheric lens L₁₂ included in the third lens group G₃ of the first optical system 1 has a rotationally asymmetric shape where the upper part in the figure is missing as shown in FIGS. 1 to 3. That is, in order that, of the luminous flux traveling from the reflecting mirror 4 toward the screen 5, a light ray s emitted so as to be the nearest to the first optical system 1 is not eclipsed by the lens L₁₂, the lens L₁₂ has the rotationally asymmetric shape where the part L_{12A} is missing that is outside the effective area of the lens L₁₂ and interferes with the light ray s traveling from the reflecting mirror 4 toward the screen 5. Thereby, even if the image plane on the screen 5 and the optical axis Z of the first optical system 1 are disposed near to each other, there is little possibility that the light ray s traveling from the reflecting mirror 4 toward the screen 5 interferes with the most magnification side lens of the first optical system 1, so that the distance between the image plane on the screen 5 and the first optical system 1 can be reduced and the first optical system 1 can be disposed nearer to the reflecting mirror 4. Consequently, the overall size of the apparatus can be reduced.

For the same purpose, a lens other than the lens L₁₂ in the first optical system 1 may have the rotationally asymmetric shape where a part is missing that is outside the effective area and interferes with the light ray s traveling from the reflecting mirror 4 toward the screen 5.

Therefore, the optical system of the present invention is capable of satisfying the following conditional expression (3):

Ymin/Ymax<0.35 (3)

where Ymin is the distance between a point the nearest to the optical axis Z of the optical system 1 and the optical axis Z of the first optical system 1 in a position within the projection image plane on the screen 5 and Ymax is the distance from a point the farthest from the optical axis Z of the first optical system 1 and the optical axis Z of the first optical system 1 in the position within the projection image plane on the screen 5.

The reduction in the overall size of the projection optical system 1 can be made more reliable by reducing the size in the direction of the optical axis of the first optical system 1 by satisfying the conditional expression (1) or (1′) and the conditional expression (2) or (2′) in addition to satisfying the conditional expression (3).

The reflecting mirror 4 may have an aspheric shape that is rotationally symmetric with respect to the optical axis Z (first example described later). In this case, the optical system is structured so that the alignment adjustment thereof is easy. It is to be noted that the concave mirror may have a rotationally asymmetric aspheric shape (second example described later). In this case, aberrations can be more improved.

The first optical system 1 and the second optical system 2 have a common optical axis, which also facilitates the alignment adjustment of the optical system.

It is desirable to dispose an aspheric lens in the first optical system 1. The aspheric shape in this case may have a rotationally symmetric aspheric shape or may have a rotationally asymmetric aspheric shape.

It is of vital importance that a reflecting optical element such as a reflecting mirror be not disposed between the first optical system 1 and the second optical system 2 in the projection optical system of the embodiment shown in FIGS. 1 to 3. This is because in the projection optical system of the present invention, an intermediate image is formed between the first optical system 1 and the second optical system 2 as mentioned above and therefore, if a reflecting optical element such as a reflecting mirror were disposed between the first optical system 1 and the second optical system 2, a problem occurs such that an image of dust adhering to the surface of the reflecting mirror is projected onto the screen 5.

While the projection type display according to the present embodiment is applied to a front projection type apparatus, it may be applied to a rear projection type apparatus.

Hereinafter, concrete examples of the projection optical system according to the present invention will be described.

As mentioned above, the reflecting surface of the reflecting mirror 4 included in the second optical system 2 and the surface of the lens L₁₂ included in the first optical system 1 are aspheric. These aspheric shapes may have an aspheric shape that is rotationally symmetric with respect to the optical axis Z or may have a rotationally asymmetric aspheric shape.

The rotationally symmetric aspheric shape is expressed by the following aspheric expression (A):

$$\begin{matrix}[ Expression 1 ] & \\ z = \frac{c {ρ}^{2}}{1 + \sqrt{1 - ( K + 1 ) {c}^{2} {ρ}^{2}}} + {\sum }_{i} {A}_{i} {ρ}^{i} ( {p}^{2} = {x}^{2} + {y}^{2} ) & ( A )\end{matrix}$$

where Z denotes a length of a perpendicular line drawn from a point on an aspheric surface at a distance y from an optical axis to a tangent plane (a plane perpendicular to the optical axis) of a vertex of the aspheric surface; ρ denotes a distance from the optical axis; c denotes a radius of curvature of the aspheric surface near in the vicinity of optical axis (1/R); K denotes an eccentricity; and Aᵢ denotes an aspheric coefficient (i=3 to 20).

The rotationally asymmetric aspheric shape (free-form shape) is expressed by the following aspheric expression (B):

$$\begin{matrix}[ Expression 2 ] & \\ z = \frac{c {ρ}^{2}}{1 + \sqrt{1 - ( K + 1 ) {c}^{2} {ρ}^{2}}} + {\sum }_{i , j} {C}_{i , j} {x}^{i} {y}^{j} ( {ρ}^{2} = {x}^{2} + {y}^{2} ) & ( B )\end{matrix}$$

where Z denotes a length of a perpendicular line drawn from a point on an aspheric surface at a distance y from an optical axis to a tangent plane (a plane perpendicular to the optical axis) of a vertex of the aspheric surface; ρ denotes a distance from the optical axis; c denotes a radius of curvature of the aspheric surface near in the vicinity of optical axis (1/R); K denotes an eccentricity; and Cᵢⱼ denotes an aspheric coefficient (i=0 to 10, j=0 to 10).

### First Example

The structure of the projection type display 20 according to the first example is as shown in FIG. 1. The structure of the projection optical system 10 is as shown in FIG. 2. The detailed structure of the lens system constituting the first optical system 1 thereof is as shown in FIG. 3.

As shown in FIGS. 2 and 3, the first optical system 1 emits a luminous flux carrying image information which luminous flux is emitted from the image display device 3 disposed on the side above the optical axis Z in the figure, toward the reflecting mirror 4 included in the optical system 2 on the reduction side. The first optical system 1 is a so-called off-axial optical system, and includes in order from the object side: a cover glass (plane-parallel plate) 6, a prism section 7, a positive first lens group G₁ including eight lenses L₁ to L₈; an aperture diaphragm 8; a second lens group G₂ including three lenses L₉ to L₁₁; and a third lens group G₃ (slightly negative near the optical axis) intended mainly for aberration correction and including one aspheric lens L₁₂.

A rotationally asymmetric shape is adopted where the part L_{12A} is missing that is outside the effective area of the aspheric lens L₁₂ and interferes with the light ray s traveling from the second optical system 2 toward the screen 5.

In the first lens group G₁ of the first optical system 1, the biconvex lens L₃ and the biconcave lens L₄ are cemented together so that chromatic aberration is excellently corrected.

Table 1 shown below shows the radius of curvature R of each element surface of the projection optical system of the first example, the surface spacing D of each element on the optical axis Z (the air spacings between the elements and the center thicknesses of the elements: in the case of the surfaces not situated on the optical axis Z, the position to which a perpendicular line is drawn from the position of each surface [the position of the vertex in the case of the surface of the reflecting mirror 4, and in the case of the surface of the screen 5, the position where the distance from the position of the vertex in the direction of the optical axis Z is shortest] down to the optical axis Z is the reference), and the refractive index N and the Abbe number v at the d-line of each element. The surfaces having the surface numbers to the left sides of which * is affixed are aspheric (the same applied to Table 3).

TABLE 1

| | | |
|---|---|---|
| f = 4.77 mm, | Fno = 3.0, | Y = 11.117 mm |

| SNo. | R | D | N_{d} | ν_{d} |
|---|---|---|---|---|
| OBJ | ∞ | 2.5000 | | |
| 1 | ∞ | 3.0000 | 1.48749 | 70.2 |
| 2 | ∞ | 17.5000 | 1.51633 | 64.1 |
| 3 | ∞ | 5.9538 | | |
| 4 | 113.4309 | 3.5664 | 1.51823 | 58.9 |
| 5 | −64.6414 | 0.2010 | | |
| 6 | 97.8745 | 4.1165 | 1.51823 | 58.9 |
| 7 | −97.8745 | 7.5089 | | |
| 8 | 26.3200 | 7.1821 | 1.49700 | 81.5 |
| 9 | −26.3200 | 1.2844 | 1.84666 | 23.8 |
| 10 | 175.4941 | 3.0201 | | |
| 11 | 75.6996 | 1.5840 | 1.67270 | 32.1 |
| 12 | 27.8126 | 1.7508 | | |
| 13 | 78.9855 | 2.5892 | 1.72825 | 28.5 |
| 14 | −42.3228 | 1.9305 | | |
| 15 | 44.8009 | 2.5770 | 1.70154 | 41.2 |
| 16 | −44.8009 | 3.8303 | | |
| 17 | −41.6959 | 1.3952 | 1.67270 | 32.1 |
| 18 | 114.6516 | 0.3497 | | |
| AP | ∞ | 17.8830 | | |
| 20 | 34.0970 | 4.6488 | 1.67270 | 32.1 |
| 21 | −202.3792 | 1.4438 | | |
| 22 | −163.7903 | 1.9075 | 1.80610 | 40.9 |
| 23 | 50.3803 | 3.4176 | | |
| 24 | −43.6837 | 1.7155 | 1.71300 | 53.9 |
| 25 | 274.1965 | 9.7106 | | |
| *26 | −31.2587 | 5.3439 | 1.49100 | 57.6 |
| *27 | −34.8881 | 91.3973 | | |
| *28 | −50.2376 | −300.0000 | (Reflecting Surface) | |
| IMG | ∞ | | | |

*Aspheric
AP: Aperture Diaphragm,
SNo.: Surface Number

Both side surfaces of the aspheric lens L₁₂ and the reflecting surface of the reflecting mirror 4 are all expressed by the aspheric expression (A) shown above. Table 2 shown below shows the aspheric coefficients in the aspheric expression (A) with respect to these aspheric shapes.

TABLE 2
Aspheric Coefficient A (26th, 27th and 28th surfaces)

| SURFACE | 26 | 27 | 28 |
|---|---|---|---|
| K | 1.4716 | 0.0120 | −1.0022 |
| A₃ | −4.1856 × 10⁻⁴ | −4.7956 × 10⁻⁴ | 2.0680 × 10⁻⁶ |
| A₄ | −4.7137 × 10⁻⁵ | −2.3794 × 10⁻⁵ | 1.7515 × 10⁻⁷ |
| A₅ | −6.9669 × 10⁻⁷ | −7.4246 × 10⁻⁷ | 4.2021 × 10⁻¹⁰ |
| A₆ | 5.8594 × 10⁻⁸ | 3.5018 × 10⁻⁸ | −1.3784 × 10⁻¹⁰ |
| A₇ | 7.1225 × 10⁻⁹ | 4.0824 × 10⁻¹⁰ | 3.8853 × 10⁻¹³ |
| A₈ | 2.4812 × 10⁻¹⁰ | 2.8752 × 10⁻¹¹ | 4.8028 × 10⁻¹⁴ |
| A₉ | 1.5402 × 10⁻¹¹ | 1.6669 × 10⁻¹² | −1.6982 × 10⁻¹⁷ |
| A₁₀ | 3.1204 × 10⁻¹³ | 1.6563 × 10⁻¹³ | −1.8414 × 10⁻¹⁷ |
| A₁₁ | 3.0458 × 10⁻¹⁴ | 5.1309 × 10⁻¹⁵ | 1.5773 × 10⁻¹⁹ |
| A₁₂ | −1.1624 × 10⁻¹⁵ | 5.5947 × 10⁻¹⁶ | −2.1705 × 10⁻²² |
| A₁₃ | 6.0628 × 10⁻¹⁷ | 7.3462 × 10⁻¹⁷ | 1.2015 × 10⁻²⁵ |
| A₁₄ | −7.2714 × 10⁻¹⁹ | 3.5477 × 10⁻²⁰ | 6.5599 × 10⁻²⁶ |
| A₁₅ | −2.7425 × 10⁻¹⁹ | 1.3129 × 10⁻²⁰ | −2.0928 × 10⁻²⁸ |
| A₁₆ | −2.0514 × 10⁻²⁰ | 2.0649 × 10⁻²¹ | 2.6935 × 10⁻²⁹ |
| A₁₇ | −1.0593 × 10⁻²¹ | 1.4205 × 10⁻²² | −5.0499 × 10⁻³² |
| A₁₈ | −2.4771 × 10⁻²³ | −3.3103 × 10⁻²³ | −5.8692 × 10⁻³³ |
| A₁₉ | 1.1202 × 10⁻²⁵ | −7.2772 × 10⁻²⁵ | −7.4107 × 10⁻³⁵ |
| A₂₀ | 2.1971 × 10⁻²⁵ | 2.8658 × 10⁻²⁶ | 1.1975 × 10⁻³⁶ |

The numerical values corresponding to the conditional expressions (1), (2), and (3) of the present example satisfy not only the conditional expressions (1), (2), and (3) but also the conditional expressions (1′) and (2′) as shown in Table 6 shown later, so that the projection optical system 10 is sufficiently compact as a whole.

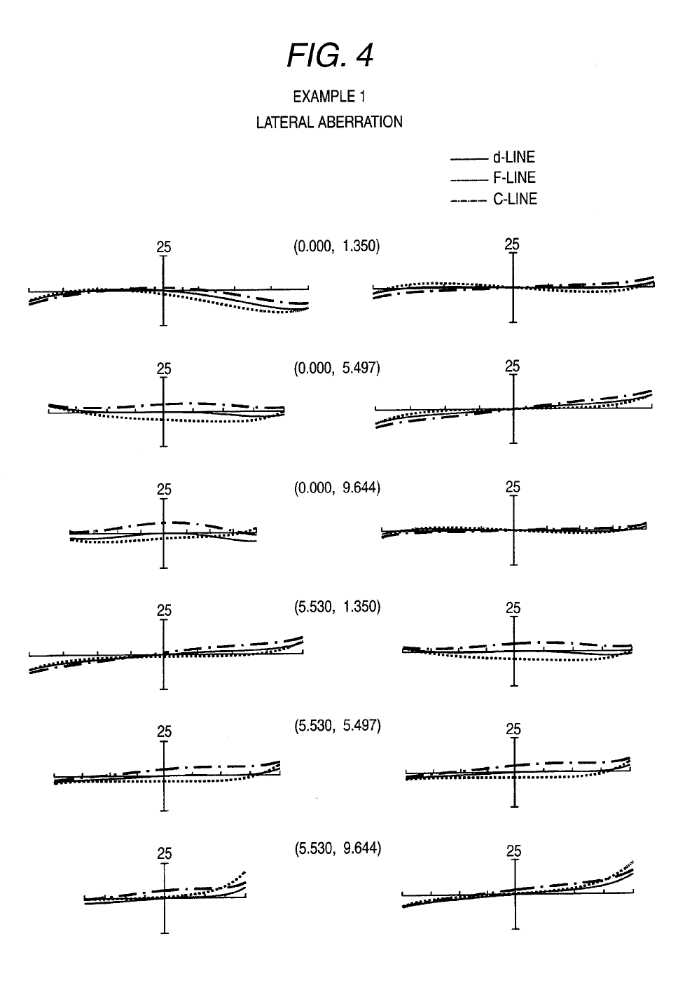

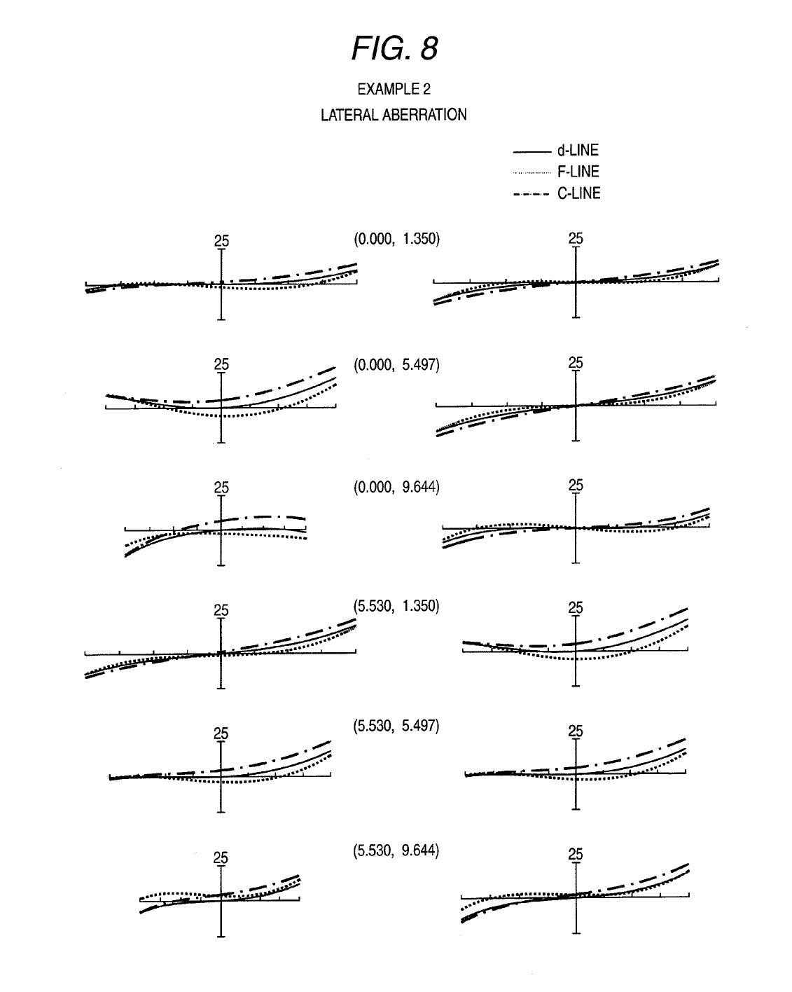

FIG. 4 shows the lateral aberrations to the wavelengths (the d-line, the F-line, and the C-line) in the positions on the screen 5 of the projection optical system according to the first example (representing the distance from the (x, y) coordinates when the x-coordinate is the exit ray height with respect to the principal ray and the y-coordinate is the shift amount from the principal rayon the display surface of the image display device 3 [both the x- and y-coordinates are arbitrary units, and the origin point is the point of intersection of the principal ray and the display surface of the image display device 3]; the same applies to FIG. 8).

As shown in FIG. 4, the projection optical system 10 according to the first example is a high-performance projection optical system capable of excellently correcting aberrations.

### Second Embodiment

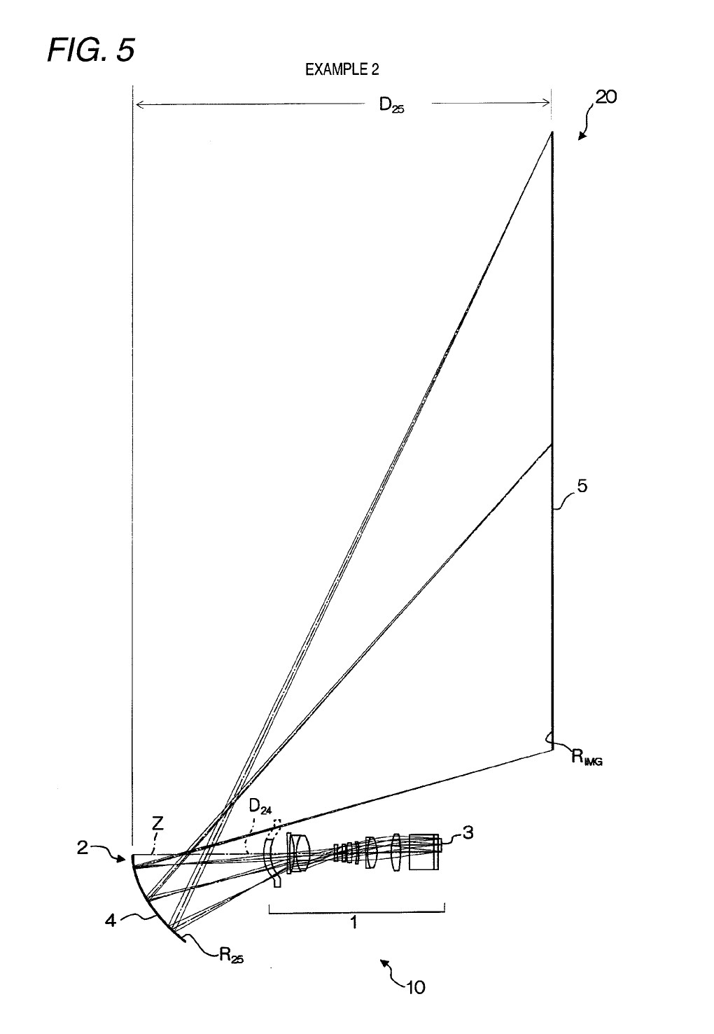

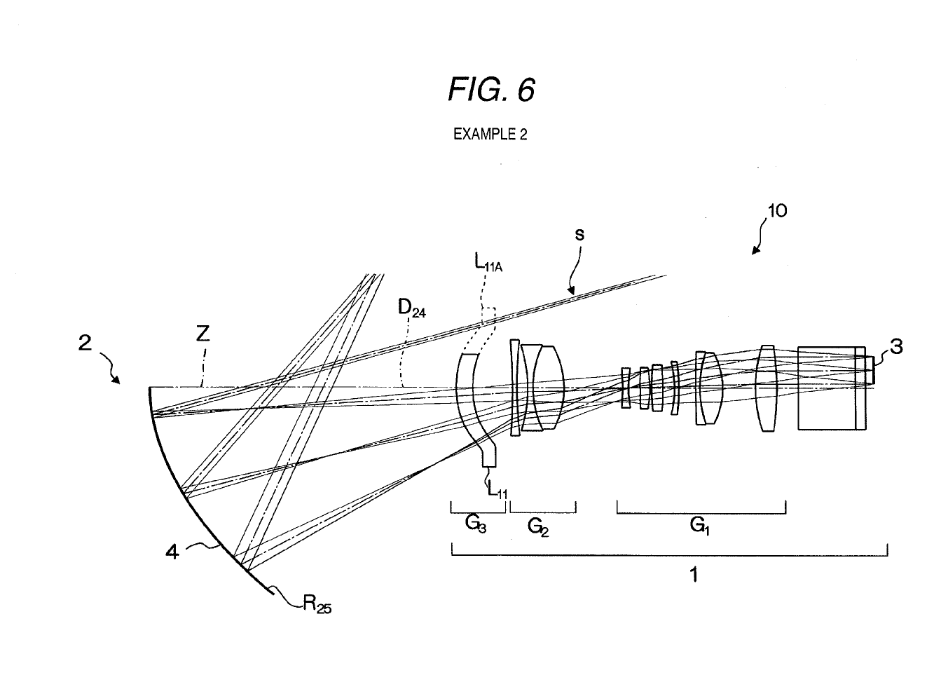

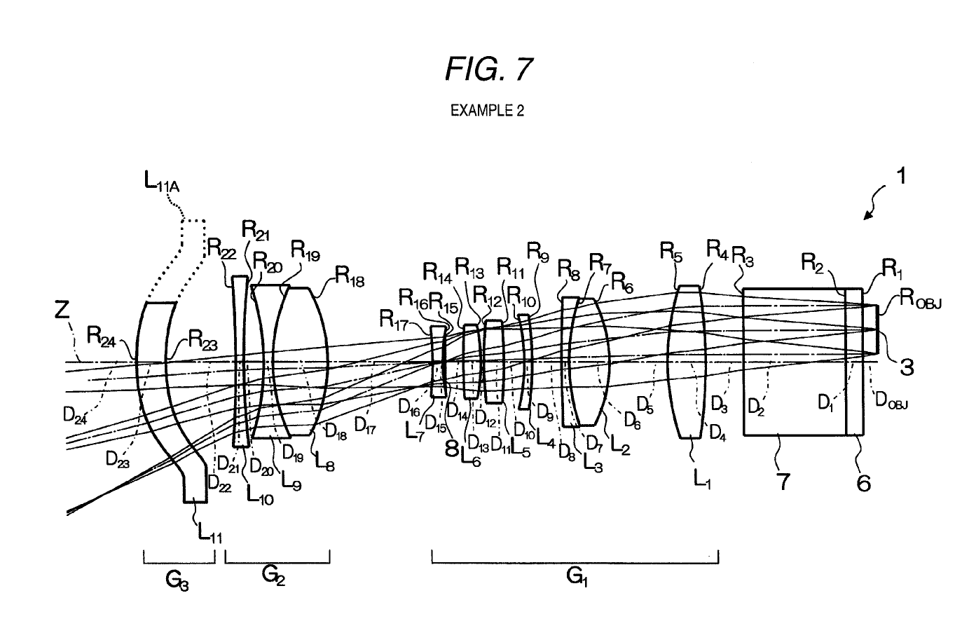

The structure of the projection type display 20 according to the second example is as shown in FIG. 5. The structure of the projection optical system 10 is as shown in FIG. 6. The detailed structure of the lens system constituting the first optical system 1 thereof is as shown in FIG. 7.

While the projection type display 20 and the projection optical system 10 according to the present example are structured substantially similarly to the projection type display 20 and the projection optical system 10 according to the first example as shown in FIGS. 6 and 7, they are different, particularly, in that the first lens group G₁ includes seven lenses L₁ to L₇. The second lens group G₂ includes three lenses L₈ to L₁₀, and the third lens group G₃ includes one aspheric lens L₁₁ that is slightly positive near the optical axis.

A rotationally asymmetric shape is adopted where the part L_{11A} is missing that is outside the effective area of the lens L₁₁ and interferes with the light ray s traveling from the reflecting mirror 4 toward the screen 5.

In the first lens group G₁ of the first optical system 1, the biconvex lens L₂ and the negative lens L₃ having a concave surface directed toward the reduction side are cemented together and in the second lens group G₂ of the first optical system 1, the biconvex lens L₈ and the biconcave lens L₉ are cemented together, so that chromatic aberration is excellently corrected in each lens.

Table 3 shown below shows the radius of curvature R of each element surface of the projection optical system of the second example, the surface spacing D of each element on the optical axis Z, and the refractive index N and the Abbe number v at the d-line of each element.

TABLE 3

| | | |
|---|---|---|
| f = 10.95 mm, | Fno = 3.0, | Y = 11.117 mm |

| SNo. | R | D | N_{d} | ν_{d} |
|---|---|---|---|---|
| OBJ | ∞ | 2.5000 | | |
| 1 | ∞ | 3.0000 | 1.48749 | 70.2 |
| 2 | ∞ | 17.5000 | 1.51680 | 64.2 |
| 3 | ∞ | 6.4873 | | |
| 4 | 81.1136 | 6.5459 | 1.48749 | 70.2 |
| 5 | −40.5375 | 9.9770 | | |
| 6 | 23.3548 | 6.9074 | 1.49700 | 81.5 |
| 7 | −34.3771 | 1.3065 | 1.80518 | 25.4 |
| 8 | −253.8600 | 5.0416 | | |
| 9 | 54.0983 | 1.3460 | 1.80518 | 25.4 |
| 10 | 30.8570 | 3.5343 | | |
| 11 | 75.6050 | 3.4607 | 1.80518 | 25.4 |
| 12 | −70.9732 | 0.5303 | | |
| 13 | 31.6689 | 2.9789 | 1.72342 | 38 |
| 14 | −135.2991 | 3.3235 | | |
| AP | ∞ | 0.2000 | | |
| 16 | −31.5700 | 1.7612 | 1.80518 | 25.4 |
| 17 | 60.6529 | 17.8631 | | |
| 18 | 26.0203 | 9.4733 | 1.59551 | 39.2 |
| 19 | −29.4879 | 1.5596 | 1.71300 | 53.9 |
| 20 | 41.6301 | 3.3647 | | |
| 21 | −134.0350 | 1.3798 | 1.77250 | 49.6 |
| 22 | 196.2920 | 12.0612 | | |
| *23 | −36.5277 | 5.0034 | 1.49100 | 57.6 |
| *24 | −36.3232 | 93.3125 | | |

| *25 | −90.5386 | −300.0000 | (Reflecting Surface) |
|---|---|---|---|
| IMG | ∞ | | |

*Aspheric
AP: Aperture Diaphragm,
SNo.: Surface Number

Both side surfaces of the aspheric lens L₁₁ of the second example are both expressed by the aspheric expression (A) shown above. Table 4 shown below shows the aspheric coefficients in the aspheric expression (A) with respect to these aspheric shapes.

TABLE 4
Aspheric Coefficient A (23rd and 24th surfaces)

| SURFACE | 23 | 24 |
|---|---|---|
| K | 1.9335 | 1.4092 |
| A₃ | −2.5834 × 10⁻⁴ | −2.5283 × 10⁻⁴ |
| A₄ | −1.0317 × 10⁻⁵ | −8.8698 × 10⁻⁶ |
| A₅ | −2.7089 × 10⁻⁷ | 1.8772 × 10⁻⁷ |
| A₆ | −1.6613 × 10⁻⁹ | −8.6671 × 10⁻⁹ |
| A₇ | 5.6746 × 10⁻¹⁰ | −5.1983 × 10⁻¹⁰ |
| A₈ | 3.2157 × 10⁻¹¹ | 7.7257 × 10⁻¹² |
| A₉ | −5.8744 × 10⁻¹³ | 2.9211 × 10⁻¹² |
| A₁₀ | 1.9101 × 10⁻¹³ | 1.9962 × 10⁻¹⁴ |
| A₁₁ | 5.9382 × 10⁻¹⁵ | 1.6517 × 10⁻¹⁵ |
| A₁₂ | 3.6532 × 10⁻¹⁷ | −1.1462 × 10⁻¹⁶ |
| A₁₃ | −2.3254 × 10⁻¹⁷ | 7.7549 × 10⁻¹⁸ |
| A₁₄ | 1.3049 × 10⁻¹⁸ | 1.3869 × 10⁻¹⁹ |
| A₁₅ | 1.9095 × 10⁻²⁰ | 5.9210 × 10⁻²¹ |
| A₁₆ | 6.7814 × 10⁻²¹ | 4.0609 × 10⁻²² |
| A₁₇ | −5.1588 × 10⁻²³ | −2.1575 × 10⁻²³ |
| A₁₈ | −1.6071 × 10⁻²³ | 6.6027 × 10⁻²⁴ |
| A₁₉ | −5.0022 × 10⁻²⁴ | −1.7624 × 10⁻²⁵ |
| A₂₀ | 2.9513 × 10⁻²⁵ | −2.4037 × 10⁻²⁷ |

The reflecting surface of the reflecting mirror 4 of the second example is expressed by the aspheric expression (B) shown above. Table 5 shown below shows the aspheric coefficients in the aspheric expression (B) with respect to the aspheric shapes.

TABLE 5
Aspheric Coefficient B (25th surface)

| | | | |
|---|---|---|---|
| K | 0.0000 | C_{2,5} | −3.06987 × 10⁻¹² |
| C_{1,0} | 0.00000 | C_{1,6} | 0.00000 |
| C_{0,1} | 1.58658 × 10⁻⁴ | C_{0,7} | −4.34351 × 10⁻¹⁴ |
| C_{2,0} | −4.47755 × 10⁻³ | C_{8,0} | 7.38849 × 10⁻¹⁴ |
| C_{1,1} | 0.00000 | C_{7,1} | 0.00000 |
| C_{0,2} | −4.48285 × 10⁻³ | C_{6,2} | 2.43941 × 10⁻¹⁴ |
| C_{3,0} | 0.00000 | C_{5,3} | 0.00000 |
| C_{2,1} | −2.39953 × 10⁻⁶ | C_{4,4} | 1.35978 × 10⁻¹³ |
| C_{1,2} | 0.00000 | C_{3,5} | 0.00000 |
| C_{0,3} | −3.23315 × 10⁻⁶ | C_{2,6} | 1.25336 × 10⁻¹³ |
| C_{4,0} | 6.39810 × 10⁻⁷ | C_{1,7} | 0.00000 |
| C_{3,1} | 0.00000 | C_{0,8} | 2.70121 × 10⁻¹⁴ |
| C_{2,2} | 1.13844 × 10⁻⁶ | C_{9,0} | 0.00000 |
| C_{1,3} | 0.00000 | C_{8,1} | 2.25121 × 10⁻¹⁵ |
| C_{0,4} | 4.92679 × 10⁻⁷ | C_{7,2} | 0.00000 |
| C_{5,0} | 0.00000 | C_{6,3} | 3.04574 × 10⁻¹⁵ |
| C_{4,1} | 6.52802 × 10⁻⁹ | C_{5,4} | 0.00000 |
| C_{3,2} | 0.00000 | C_{4,5} | 4.36014 × 10⁻¹⁵ |
| C_{2,3} | 5.88565 × 10⁻⁹ | C_{3,6} | 0.00000 |
| C_{1,4} | 0.00000 | C_{2,7} | 2.75731 × 10⁻¹⁵ |
| C_{0,5} | 1.70032 × 10⁻⁹ | C_{1,8} | 0.00000 |
| C_{6,0} | −2.26595 × 10⁻¹⁰ | C_{0,9} | 3.70996 × 10⁻¹⁶ |
| C_{5,1} | 0.00000 | C_{10,0} | −8.93067 × 10⁻¹⁸ |
| C_{4,2} | −3.39284 × 10⁻¹⁰ | C_{9,1} | 0.00000 |
| C_{3,3} | 0.00000 | C_{8,2} | 2.69402 × 10⁻¹⁷ |
| C_{2,4} | −3.28225 × 10⁻¹⁰ | C_{7,3} | 0.00000 |
| C_{1,5} | 0.00000 | C_{6,4} | 2.71856 × 10⁻¹⁷ |
| C_{0,6} | −7.06753 × 10⁻¹¹ | C_{5,5} | 0.00000 |
| C_{7,0} | 0.00000 | C_{4,6} | 3.07040 × 10⁻¹⁷ |
| C_{6,1} | −6.56985 × 10⁻¹² | C_{3,7} | 0.00000 |
| C_{5,2} | 0.00000 | C_{2,8} | 1.59047 × 10⁻¹⁷ |
| C_{4,3} | −6.11081 × 10⁻¹² | C_{1,9} | 0.00000 |
| C_{3,4} | 0.00000 | C_{0,10} | 1.49256 × 10⁻¹⁸ |

The numerical values corresponding to the conditional expressions (1), (2), and (3) of the present example satisfy not only the conditional expressions (1), (2), and (3) but also the conditional expressions (1′) and (2′) as shown in Table 6 shown later, so that the projection optical system 10 is sufficiently compact as a whole.

FIG. 8 shows the lateral aberrations to the wavelengths (the d-line, the F-line, and the C-line) in the positions on the screen 5 of the projection optical system according to the second example.

As shown in FIG. 8, the projection optical system 10 according to the second example is a high-performance projection optical system capable of excellently correcting aberrations.

TABLE 6

| | | EXAM- | EXAM- |
|---|---|---|---|
| | | PLE 1 | PLE 2 |
| | T1 | 88.96 | 97.62 |
| | Y | 11.12 | 11.12 |
| CONDITIONAL EXPRESSION (1) | T1/Y | 8.00 | 8.78 |
| | T12 | 91.40 | 93.31 |
| | f1 | 18.70 | 21.20 |
| CONDITIONAL EXPRESSION (2), (2)′ | T12/f1 | 4.89 | 4.40 |
| | Yₘᵢₙ | 74.76 | 73.42 |
| | Yₘₐₓ | 609.71 | 596.11 |
| CONDITIONAL EXPRESSION (3) | Yₘᵢₙ/Yₘₐₓ | 0.12 | 0.12 |

The projection optical system and the projection type display using the same according to the present invention are not limited to the above-described ones, but various modifications are possible. For example, the lens arrangement of the first optical system 1 and the curve configuration and position of the reflecting mirror 4 included in the second optical system 2 may be set as appropriate.

Further, it is to be noted that two or more aspheric lenses may be disposed in the first optical system 1.

What is claimed is:

1. A projection optical system that projects and magnify an image being on an image display device which is a reduction-side conjugate plane of a pair of conjugate planes, onto a screen which is a magnification-side conjugate plane of the pair of conjugate planes, the projection optical system comprising, in order from an image-display-device side:
a first optical system that includes a plurality of lenses and forms an intermediate image from the image being on the image display device; and
a second optical system that consists of a concave mirror having a concave surface directed toward the first optical system and forms the intermediate image on the screen,
wherein
the first optical system includes, in order from the side of the image display device:
a first lens group having a positive refractive power;
a second lens group having a negative refractive power; and
a third lens group including at least one aspheric lens.

2. The projection optical system according to claim 1,
wherein focus adjustment is performed by moving the second optical system and the first lens group and the second lens group of the first optical system in a direction of an optical axis.

3. The projection optical system according to claim 1, wherein the concave mirror has a rotationally symmetric aspheric shape.

4. The projection optical system according to claim 1, wherein the concave mirror has a rotationally asymmetric aspheric shape.

5. The projection optical system according to claim 1, wherein the aspheric lens of the first optical system has a rotationally symmetric aspheric shape.

6. The projection optical system according to claim 1, wherein the first optical system and the second optical system have a common optical axis.

7. A projection type display comprising the projection optical system according to claim 1.
